(19) United States
(12) Patent Application Publication
(10) Pub. No.: US 2006/0074957 A1
(43) Pub. Date: Apr. 6, 2006

(54) Method of configuration management of a computer system

(75) Inventors: Masayuki Yamamoto, Sagamihara (JP); Masayasu Asano, Yokohama (JP); Yasunori Kaneda, Sagamihara (JP); Takayuki Nagai, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/987,566

(22) Filed: Nov. 12, 2004

(30) Foreign Application Priority Data
Sep. 29, 2004 (JP) 2004-283033

(51) Int. Cl. G06F 17/30

(52) U.S. Cl. 707/101

(57) ABSTRACT

A configuration management computer and program for managing volume configuration of a computer system are provided. This program collects configuration information from a host computer, switch, and storage system, that are objects for management, and creates correspondence of usage between a replica volume and a replica configuration definition. Once the storage administrator designates the original volume and usage, the configuration management program allocates the replica volume to the host computer on the basis of the replica volume allocation destination computer, a replica volume creation destination storage system, and a replica function that correspond to the designated usage.

### CROSS-REFERENCE TO RELATED APPLICATION

This application relates to and claims priority from Japanese Patent Application No. 2004-283033, filed on Sep. 29, 2004, the entire disclosure of which is incorporated herein by reference.

### BACKGROUND OF THE INVENTION

The technology disclosed in the present invention relates to configuration for management of a computer system containing a plurality of computers and a plurality of storage systems. Particularly, it relates to a method of managing volume configuration of a storage system, and a management computer for managing the volume configuration.

The amount of data that a computer system can store has been increasing substantially. One result has been the use of Storage Area Networks (SAN). A SAN is a network configuration in which numbers of host computers and large-scale storage systems are connected together, often using a switch or network.

Compared to the increase in the amount of data, however, the number of storage administrators available to operate storage systems and networks is not increasing as fast. Consequently, the data amount of handled by each storage administrator increases, and the storage administrators face the issue of how to effectively manage the increasing data.

Some prior art discloses technology for simplifying volume allocation operation for a host computer. Japan Patent Application Laid-Open No. 2001-142648 discloses a technology in which a management computer executes volume allocation operation for a host computer. Japan Patent Application Laid-Open No. 2003-303052 discloses a technology in which a management computer executes volume allocation operation for a host computer in accordance with conditions for volume allocation defined beforehand by a storage administrator.

### SUMMARY OF THE INVENTION

In consideration of the storage systems that continue to scale, the inventors, using a replica function, have found issues that are discussed below. See, e.g. FIG. 18.

For the purpose of backing up business data or for disaster control, computer systems have used an intra replica function or inter replica function provided by a storage system to create a plurality of replicas for a volume (often abbreviated to VOL) 26000 of a storage system 20000. For example, in FIG. 18, VOL1 is a volume that obtains replica VOL2 through an intra replica function, and further obtains replica VOL3 through another inter replica function. VOL1 for storing data that is a copy source of a replica function is called “an original volume.” VOL2 or VOL3 that are copy destinations of the data are called “a replica volume.” In addition, a volume pair of the copy source and copy destination, i.e., a pair of VOLL and VOL2, as well as a pair of VOL1 and VOL3, is called “a copy pair.”

To create a replica of certain data, a storage administrator designates an original VOL, a replica function of a storage system, a storage system of a replica VOL creation destination, replica VOL, and a replica VOL allocation destination computer. However, when the storage system is complicated and the replica function is diversified, expertise in the computer system is required to create a replica that the storage administrator desires. This simplifies the volume allocation operation for the host computer, but it is still necessary to be knowledgeable about the computer system, regardless of the configuration information of the storage system or host computer required for copy pair creation.

Moreover, as the storage system size increases, storage administrators operate and manage a single system, each having different experience and knowledge of the storage system. In this situation, senior storage administrators must give instructions on operation so that problems, such as degradation of the entire storage system, are not generated by an inexperienced manager creating a replica. Consequently, the burden of management imposed on the senior managers increases.

In an embodiment of the present invention, a management computer, which manages a plurality of computers and a storage system having a storage region for storing data used by the computer, receives, via an input portion, designations of usages of a first storage region and second storage region for storing data replicated from data stored in the first storage region, and provides a computer corresponding to the designation of the usage and the second storage region. According to the above embodiment, configuration management of multiple volumes can be simplified.

### BRIEF DESCRIPTION OF THE DRAWINGS

FIG. 1 is a diagram showing a configuration of a computer system in one embodiment;

FIG. 2 is a diagram showing a detailed configuration example of a host computer in the embodiment;

FIG. 3 is a diagram showing a detailed configuration of a storage system in the embodiment;

FIG. 4 is a diagram showing a detailed configuration of a switch in the embodiment;

FIG. 5 is a diagram showing a detailed configuration of a management computer in the embodiment;

FIG. 6 is a diagram showing a configuration of an LU management table of the host computer in the embodiment;

FIG. 7 is a diagram showing a configuration of a volume table of the storage system in the embodiment;

FIG. 8 is a diagram showing a configuration of an intra replica table of the storage system in the embodiment;

FIG. 9 is a diagram showing a configuration of an inter replica table of the storage system in the embodiment;

FIG. 10 is a diagram showing a configuration of a device discovery list of the management computer in the embodiment;

FIG. 11 is a diagram showing a configuration of a usage management table of the management computer in the embodiment;

FIG. 12 is a diagram showing a configuration of a storage network connection management table of the management computer in the embodiment;

FIG. 13 is a diagram showing a configuration of a replica function management table of the management computer;

FIG. 14 is a diagram showing a processing sequence of replica creation processing which is implemented by a storage administrator and the configuration management program in the embodiment;

FIG. 15 is a detailed flowchart of configuration information collection processing of the system executed by the configuration management program in the embodiment;

FIG. 16A is a detailed flowchart of replica volume candidate extraction processing executed by the configuration management program in the embodiment;

FIG. 16B is a detailed flowchart of the replica volume candidate extraction processing executed by the configuration management program in the embodiment;

FIG. 17 is an input-output screen provided by the configuration management program in the embodiment;

FIG. 18 is a diagram explaining a conventional configuration of a storage system and the replica function of the storage system;

FIG. 19 is a diagram showing a conventional processing sequence of the replica creation processing which is implemented by a storage administrator and a configuration management program; and

FIG. 20 is an input-output screen provided by the conventional configuration management program.

### DESCRIPTION OF THE PREFERRED EMBODIMENT

Embodiments of the present invention are explained below with reference to the drawings. Note that the explanations are exemplary and are not intended to limit the present invention. In addition, “a storage administrator” is often termed “a user” in the explanation below.

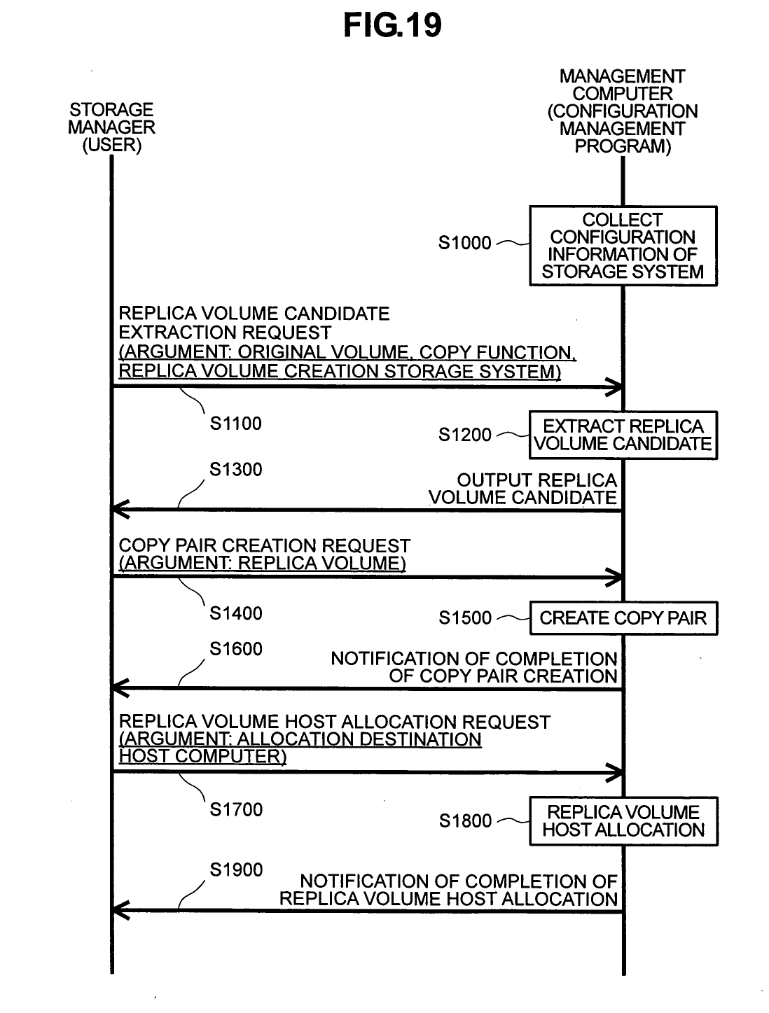

A conventional replica configuration creation sequence is first explained using FIG. 19. Then, the first embodiment is explained.

A configuration management program periodically collects the configuration information of a storage system (Step S1000). Configuration information here means the VOL configuration information of each storage system and information of an available replica function.

A user requests the configuration management program for replica VOL candidate extraction (Step S1100). At this time the user designates an original VOL, replica function, and replica VOL creation destination storage system. The configuration management program performs replica VOL candidate extraction processing based on the received information (Step S1200), and returns replica VOL candidates to the user (Step S1300). The user selects a volume to be the replica VOL from among the volumes that are replica VOL candidates, and requests the configuration management program for copy pair creation by means of the VOL (Step S1400).

The configuration management program performs processing of copy pair creation taking a designated volume as a replica volume (Step S1500), and, once the copy pair creation is completed, returns a notification of completion to the user (Step S1600). Specifically, the configuration management program issues a command for replica configuration creation to the storage system that includes the designated original VOL and replica VOL. Finally, the user designates a replica VOL allocation destination and requests a replica VOL host allocation, from the configuration management program (Step S1700).

The configuration management program allocates the replica VOL to a designated host computer (Step S1800), and, once the allocation is completed, returns a notification of completion to the user (Step S1900). Specifically, the configuration management program issues a command for changing the configuration definition of the VOL to the storage system comprising a replica VOL, and enables recognition of the replica VOL through an I/O port that is accessible from the designated host computer.

This is a conventional replica configuration creation sequence.

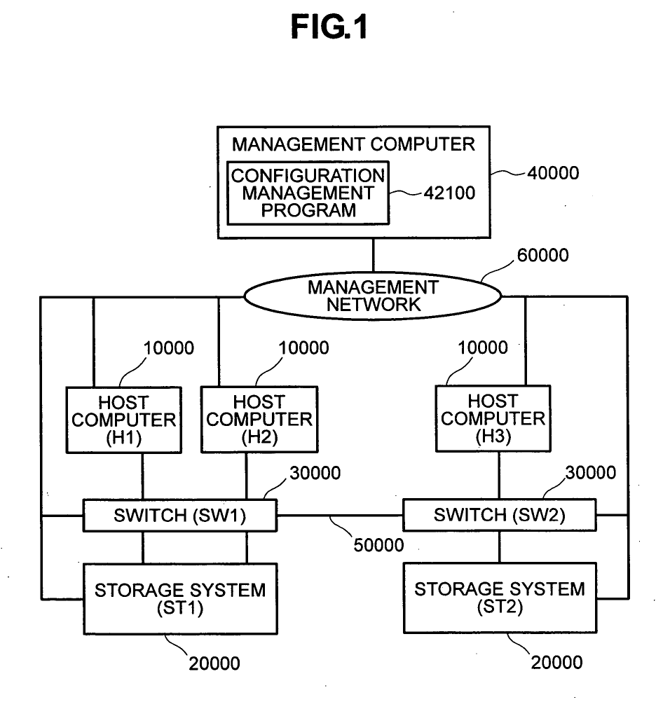

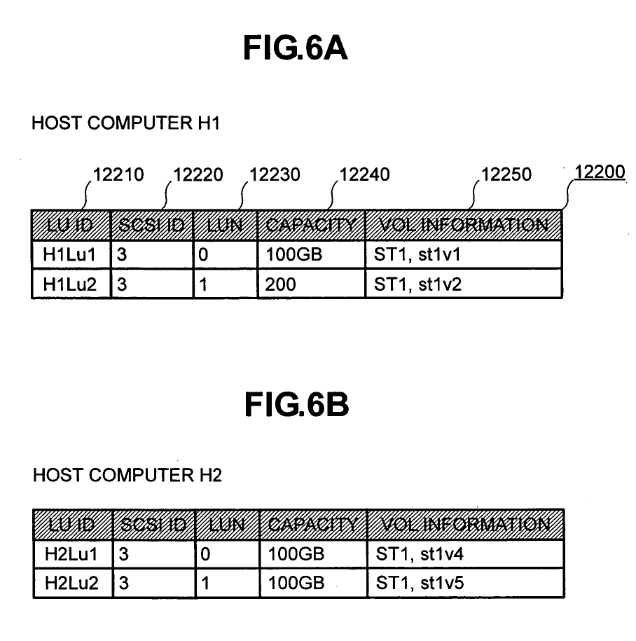

FIGS. 1 to 5 show exemplary configurations of the storage system and of a device connected to the storage system, and FIGS. 6 to 13 show management information that each device includes.

The configuration of the storage system is shown in FIG. 1. One or more host computers 10000, one or more storage systems 20000, and one or more switches 30000 are connected with each other by a storage network 50000. Further, each host computer 10000, each storage system 20000, and each switch 30000 are connected to a management computer 40000 via a management network 60000. Storage network 50000 between the host computer and storage system and between the storage systems may be directly connected between the systems without having switches 30000 lay therebetween.

For convenience of the following explanation, in Embodiment 1, host computers H1 and H2 are connected to storage system ST1 via switch SW1, host computer H3 is connected to storage system ST2 via switch SW2, and the storage systems ST1 and ST2 are connected with each other via switches SW1 and SW2. In addition, the storage network 50000 is a network that uses an FC (Fibre Channel) protocol, and the management network 60000 is a network that uses an IP protocol.

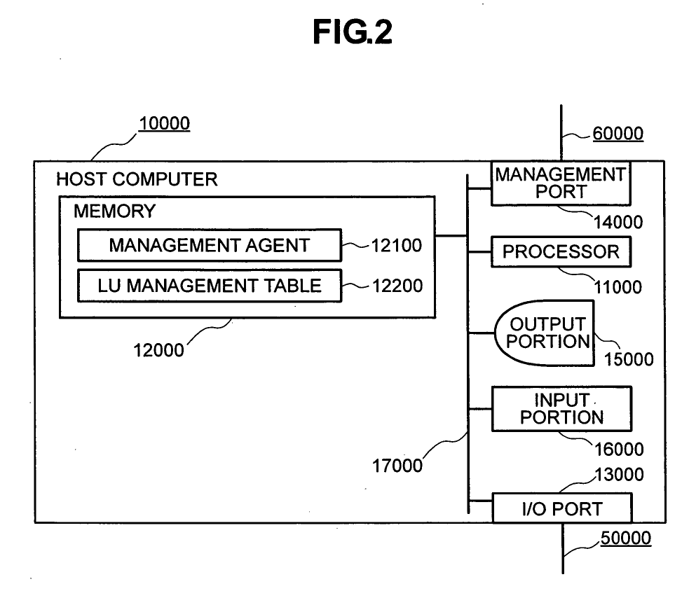

FIG. 2 shows a detailed configuration example of the host computer 10000. Host computer 10000 includes a processor 11000, memory 12000, one or more I/O ports 13000 to be connected to the storage network 50000, a management port 14000 to be connected to the management network 60000, an output portion 15000, such as a display device, for outputting a process result, and an input portion 16000 such as a keyboard, mouse, or the like; and these are connected to each other by an internal bus 17000. A management agent 12100 for acquiring and setting configuration information of the host computer, and a Logical Unit (LU) management table 12200 for managing an LU which is a storage region used by the host computer are stored in the memory 12000. A function of the management agent 12100 is realized by processor 11000 loading the management agent program 12100 from a storage medium (not shown), such as a hard disk, into the memory 12000 and executing the management agent program. Further, although not shown, an Operating System (OS) and an application program that performs a process which involves data access to the LU are loaded from the storage medium into the memory 12000, and the processor 11000 executes these programs, thereby reading and writing data of the LU.

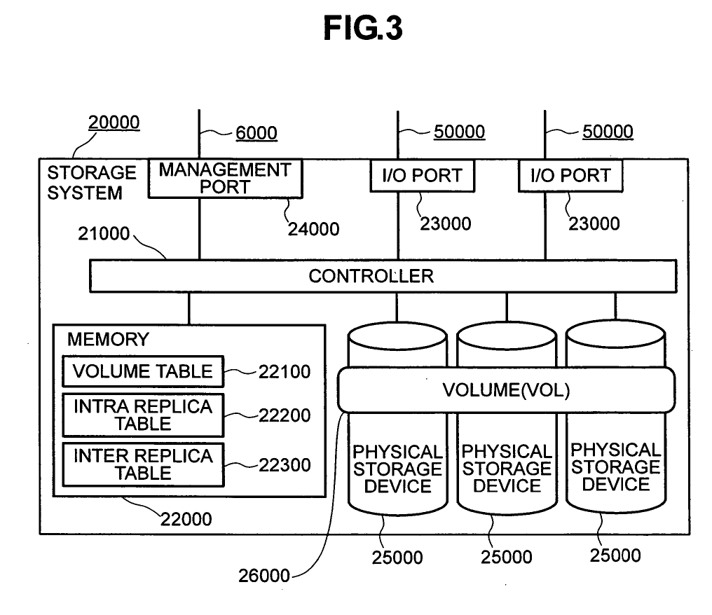

FIG. 3 shows a detailed configuration example of storage system 20000. Storage system 20000 includes a controller 21000 for performing control within the storage system, one or more I/O ports 23000 to be connected to the storage network 50000, a management port 24000 to be connected to the management network 60000, and one or more volumes 26000 that are the LUs to be provided to the host computer; and these are connected to each other via the controller 21000. A control program (not shown) for performing control within the storage system, a volume management table 22100 for managing a volume inside the storage system, an intra replica table 22200 for holding management information regarding the replica function within the storage system, and an inter replica table 22300 for holding management information on the replica function between the storage systems are stored in a program memory 22000. These tables are loaded from the storage medium (not shown) during system start-up, and processed by the controller 21000.

Note that in this embodiment, the number of the I/O ports 23000 and the number or capacity of volumes 26000 are not considered. Furthermore, volumes 26000 may be configured by physical storage devices 25000 such as a plurality of hard disks, or by a single physical storage device, as shown in the figure.

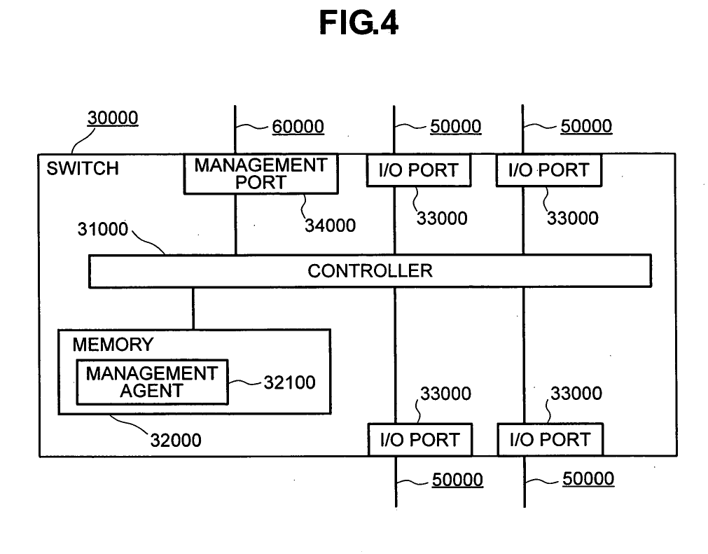

FIG. 4 shows a detailed configuration example of the switch 30000. Switch 30000 includes a controller 31000 for controlling the switch, memory 32000, one or more I/O ports 33000 to be connected to the storage network 50000, and a management port 34000 to be connected to the management network 60000; and these are connected to each other via the controller 31000. A management agent 32100 for acquiring and setting configuration information of the switch is stored in the memory 32000. A function of the management agent 32100 is realized by the controller 31000 loading the management agent 32100 from a storage medium (not shown), such as a hard disk, into the memory 32000 and executing the management agent. Further, although not shown, a control program of the switch is loaded from the storage medium into the memory 32000, and the controller 31000 executes this program, thereby controlling a data path of a data network.

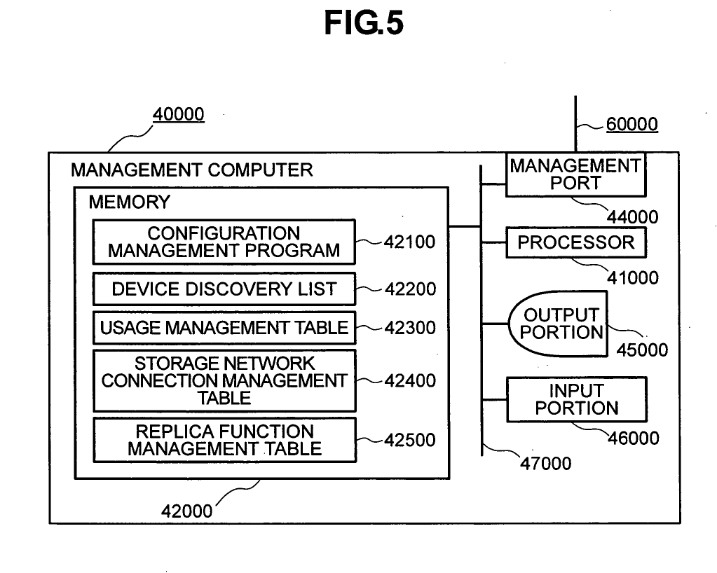

FIG. 5 shows a detailed configuration of the management computer 40000. Management computer 40000 includes a processor 41000, memory 42000, a management port 44000 to be connected to the management network 60000, an output portion 45000, such as a display device, for outputting a process result, and an input portion 46000 such as a keyboard, mouse or the like; and these are connected to each other by an internal bus 47000. A configuration management program 42100 to be described later, a device discovery list 42200 used by the configuration management program to specify a device for the storage system, a usage management table 42300 for managing a usage of a replica volume, which will be described later, a storage network connection management table 42400 for maintaining a connection between the host computer and storage system on the storage network, and a replica function management table 42500 for holding information about the replica function of the storage system are stored in memory 42000. A function of the configuration management program 42100 is realized by the processor 41000 loading the configuration management program 42100 from a storage medium (not shown), such as a hard disk, into the memory 42000, and executing the configuration management program. Further, although not shown, an OS is loaded from the storage medium into the memory 42000, and the processor 11000 executes these programs.

FIG. 6 shows an example of the LU management table 12200 of host computer 10000. LU management table 12200 contains a field 12210 for registering an LU ID which is a unique identifier for each LU in the host computer, a field 12220 for registering a target ID of an SCSI (Small Computer System Interface) of each LU, a LUN field 12230 for registering a SCSI logical unit number, a field 12240 for registering a capacity, and a volume information field 12250 for registering volume information of the storage system that configures the LU. Specifically, the volume information field 12250 registers information of a device identifier, volume identifier, or the like of the storage system, which can be acquired using an inquiry command of the SCSI.

For convenience of the following explanation, FIG. 6 shows that the host computer H1 holds two LUs indicated by the LU IDs H1 Lu1 and H1Lu2, while the host computer H2 holds two LUs indicated by the LU IDs H2Lu1 and H2Lu2.

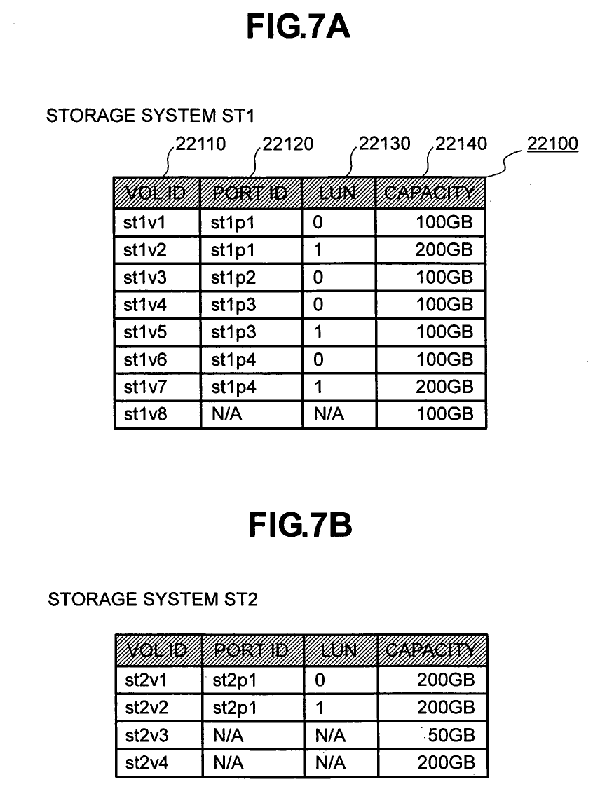

FIG. 7 shows an example of the volume management table 22100 of storage system 20000. Volume management table 22100 contains a volume ID 22110 which is a unique identifier of a volume inside the storage system, a field 22120 for registering a port ID, which is an access path, for a setting where the host can recognize the volume as an LU (hereinafter referred to as “host-allocation-completed”), a SCSI logical unit number 22130 when the volume is indicated as host-allocation-completed, and a field 22140 for registering a capacity. Note that in the case of a setting where the host cannot recognize the volume as an LU (hereinafter referred to as “host-allocation incomplete”), a value of “N/A (Not Applicable)” is registered in port ID field 22120 and LUN field 22130.

FIG. 7 shows storage system ST1 holds eight volumes indicated by the volume IDs of st1v1 through st1v8. The volumes other than st1v8 are host-allocation-completed. The storage system ST2 holds four volumes indicated by the volume IDs of st2v1 through st2v4. St2v1 and st2v2 are host-allocation completed.

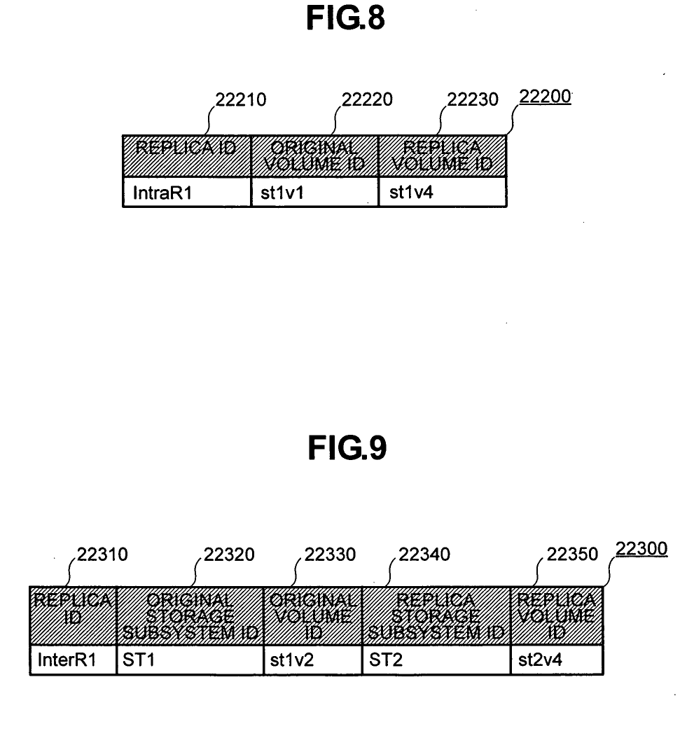

FIG. 8 shows an example of intra replica table 22200. Intra replica table 22200 contains a field 22210 for registering a replica ID which is a unique identifier of an intra replica in the storage system, a field 22220 for registering a volume ID indicating an original volume which is a replica source, and a field 22230 for registering a volume ID indicating a replica volume which is a replica destination. When using the intra replica function of the storage system, a new entry may be added to the present intra replica table 22200. In the case of FIG. 8, for example, one copy pair indicated by the replica ID of IntraR1 exists in storage system ST1, and it is shown that the original volume is st1v1 and the replica volume is st1v4.

FIG. 9 shows an example of inter replica table 22300 of storage system 20000. Inter replica table 22300 contains a field 22310 for registering a replica ID which is a unique identifier of an inter replica within the storage system, a field 22320 for registering a device ID indicating a storage system which is a replica source, a field 22330 for registering a volume ID indicating an original volume which is a replica source, a field 22340 for registering the device ID indicating a storage system which is a replica destination, and a field 22350 for registering a volume ID indicating a replica volume which is the replica destination. When using the inter replica function of the storage system, a new entry may be added to the present inter replica table 22300.

In the case of FIG. 9, for example, one copy pair indicated by replica ID InterR1 exists between storage systems ST1 and ST2, and it is shown that the original volume is st1v2 for ST1, and the replica volume is st2v4 for ST2.

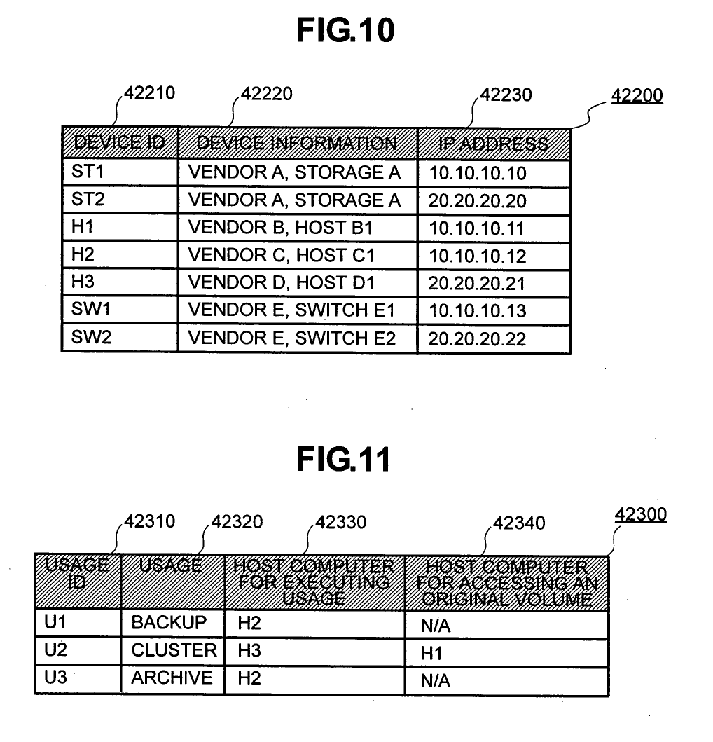

FIG. 10 shows an example of device discovery list 42200 of management computer 40000. The device discovery list 42200 contains a field 42210 for registering a device ID of a discovery object device, a field 42220 for registering device information such as the vendor name or model name of the discovery object device, and a field 42230 for registering an IP address of the management port, which is used for connecting to the management port of the discovery object device.

In Embodiment 1, management computer 40000, which includes the configuration management program 42100, needs to detect storage systems ST1 and ST2, host computers H1, H2 and H3, and switches SW1 and SW2, thus the information of each device is maintained as shown in FIG. 8.

Note that these information items may be registered in advance by the storage administrator from management computer 40000. Moreover, these information items may be configured automatically by using a name service or the like on the storage network or management network.

FIG. 11 shows an example of the usage management table 42300 of management computer 40000. “Usage” here means a function or role of an application or program which is different from that which the primary application or program on the host computer accessing the original VOL uses the replica VOL. For example, when backing up the VOL of a database application, a backup application is considered the usage, whereas the database application is the primary application. A function provided by the application or program for this usage, may be operated on the same computer as the host computer accessing the original VOL, or may be operated on a different host computer. However, to reduce increased access load on the original VOL, the replica VOL is created as a copy of the data of the original VOL by means of the replica function, and the host that executes the backup application accesses the replica VOL. Usage management table 42300 contains a field 42310 for registering a usage ID for uniquely identifying a usage, a field 42320 for registering a usage name, a usage execution host field 42330 for registering a host computer in which an application or program which is the usage is executed, and a field of a host computer for accessing an original VOL 42340 for registering a host computer in which the primary application is executed.

In the case of FIG. 11, for example, three usages indicated by usage Ids U1, U2, and U3 are registered. Specific examples for the usage management table are now described with explanations of the following three usages. Usage ID U1 is a backup. In this embodiment, a backup application or program is executed on the host computer H2. Therefore, H2 is registered in the usage execution host field. The host computer executing the primary application or program that uses the original VOL may be any host computer. In such a case, a value of “N/A (Not Applicable)” is registered in the field of a host computer for accessing an original VOL.

Usage ID U2 is a cluster. For a cluster application, a host computer where the primary program using the original VOL as a normal system is operated, and a host computer where a program using the replica VOL as a standby system is operated, are limited. Therefore, in this embodiment, host computer H3, where the program is operated as the standby system, is registered in the usage execution host field, and host computer H1, where the program is operated as the normal system, is registered in the field of a host computer for accessing an original VOL.

Usage ID U3 is an archive. In this embodiment, an archive application or program is executed on the host computer H2. Therefore, H2 is registered in the usage execution host field. The host computer executing the primary application or program that uses the original VOL may be any host computer. Therefore, “N/A” is registered in the field of a host computer for accessing an original VOL. Further, the usage execution host that executes the mail data archive application sometimes receives an access from the host executing the primary application (the mail application executed in the mail server), thus the usage execution host needs to be either a host that can communicate with the host computer for accessing an original VOL or the host computer for accessing an original VOL itself. A creation method and usages in Embodiment 1 of usage table 42300 are described later.

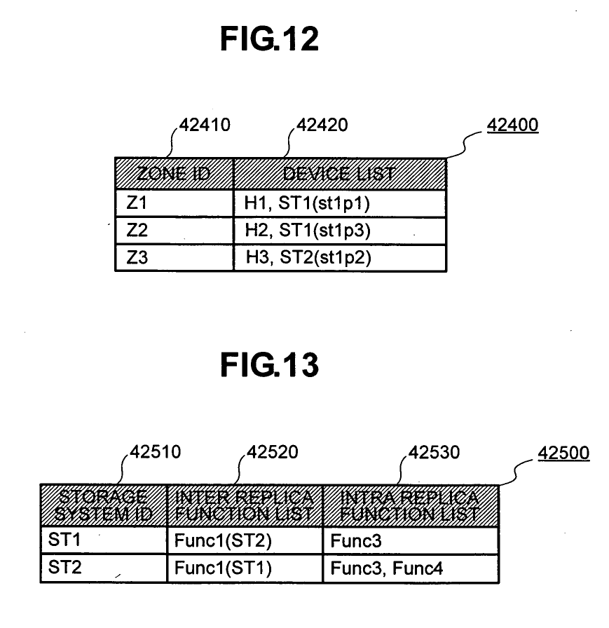

FIG. 12 shows an example of the storage network connection table 42400 of management computer 40000. The storage network connection table 42400 contains a field 42410 for registering a Zone ID, which is an identifier in a region that each device can access, and a field 42420 for registering a list of devices that belong to the zone.

In the case of FIG. 12, for example, three zones indicated by the Zone Ids of Z1, Z2, and Z3 are registered. A creation method and usages in Embodiment 1 of the storage network connection table 42400 are described later.

FIG. 13 shows an example of the replica function management table 42500 of management computer 40000. The replica function management table 42500 contains a field 42510 for registering the device ID of the storage system comprising the replica function, a field 42520 for registering the list of inter replica function of the storage system, and a field 42530 for registering the list of the intra replica function of the storage system.

In the case of FIG. 13, for example, an inter replica function Func1 exists between ST1 and ST2, an intra replica function Func3 exists in ST1, and intra replica functions Func3 and Func4 exist in ST2. A creation method and usages in Embodiment 1 of storage network connection table 42400 are described later.

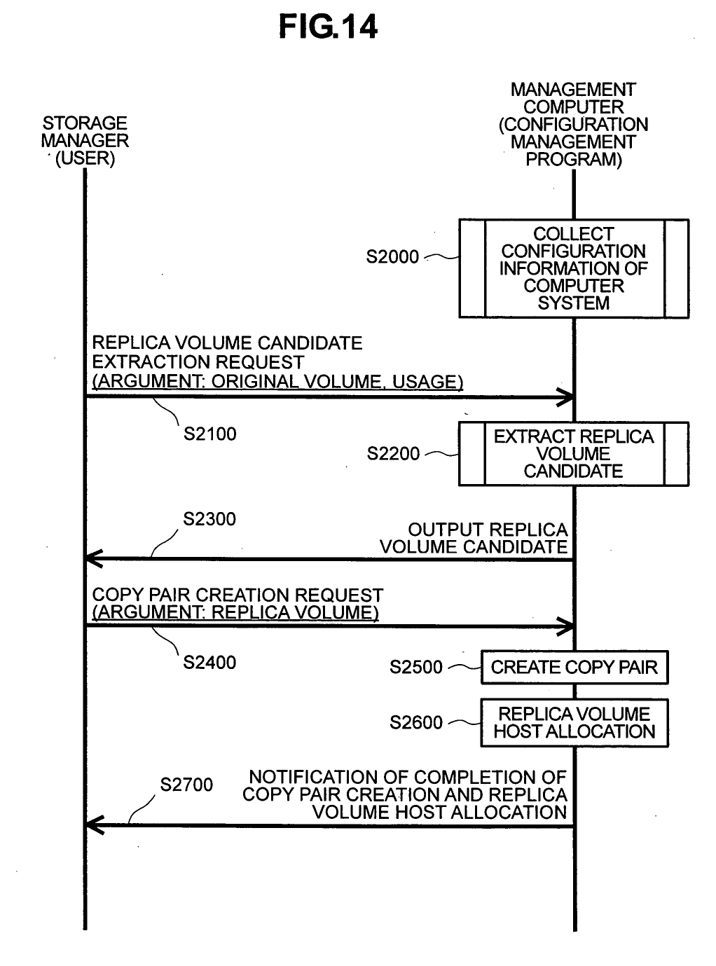

Next, a sequence for replica configuration creation in Embodiment 1 is described using FIG. 14. First, the configuration management program periodically collects the configuration information of the computer system (Step S2000). Detailed processing of this step is described later.

A user requests the configuration management program for a replica volume candidate extraction (Step S2100). At this time, the user designates an original volume and usage. The configuration management program performs replica volume candidate extraction processing based on the received information (Step S2200), and returns replica volume candidates to the user (Step S2300). Detailed processing of Step S2200 is described later.

The user selects a volume from among the volumes of replica volume candidates to designate a replica volume, and requests the configuration management program for a copy pair creation (Step S2400). The configuration management program performs copy pair creation processing with the designated volume as a replica volume (Step S2500), and further performs host allocation processing of the replica volume to the host computer corresponding to the usage (Step S2600). After completing steps S2500 and S2600, the configuration management program returns a notification of completion to the user (Step S2700).

This is the sequence for replica configuration creation of Embodiment 1. As above, in the sequence for replica configuration creation, it is clear from this embodiment that the items designated by the user decrease compared to the conventional sequence.

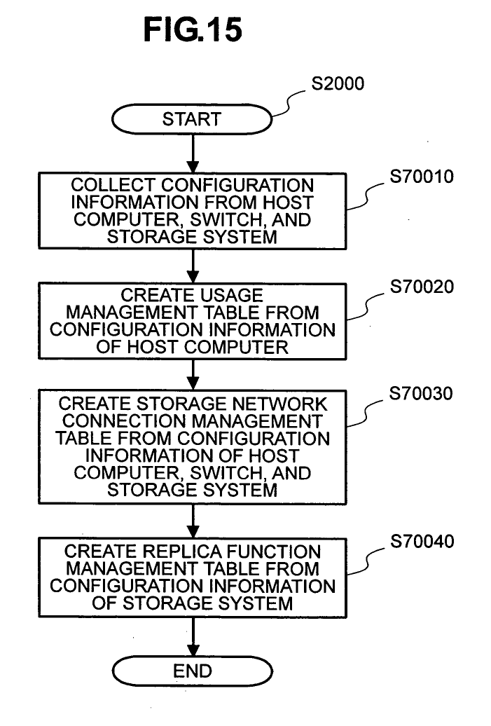

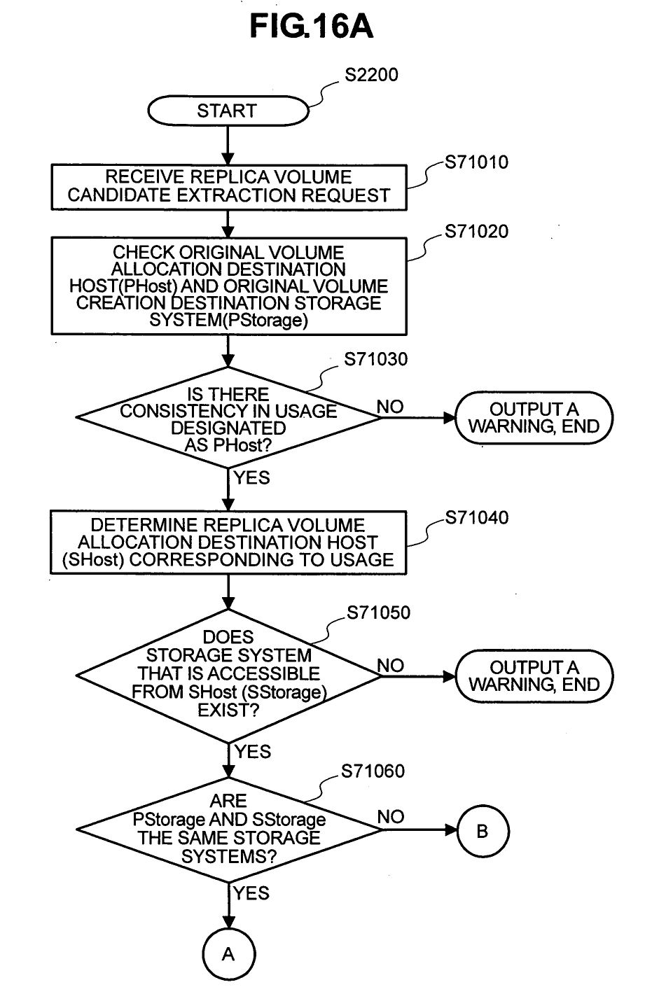

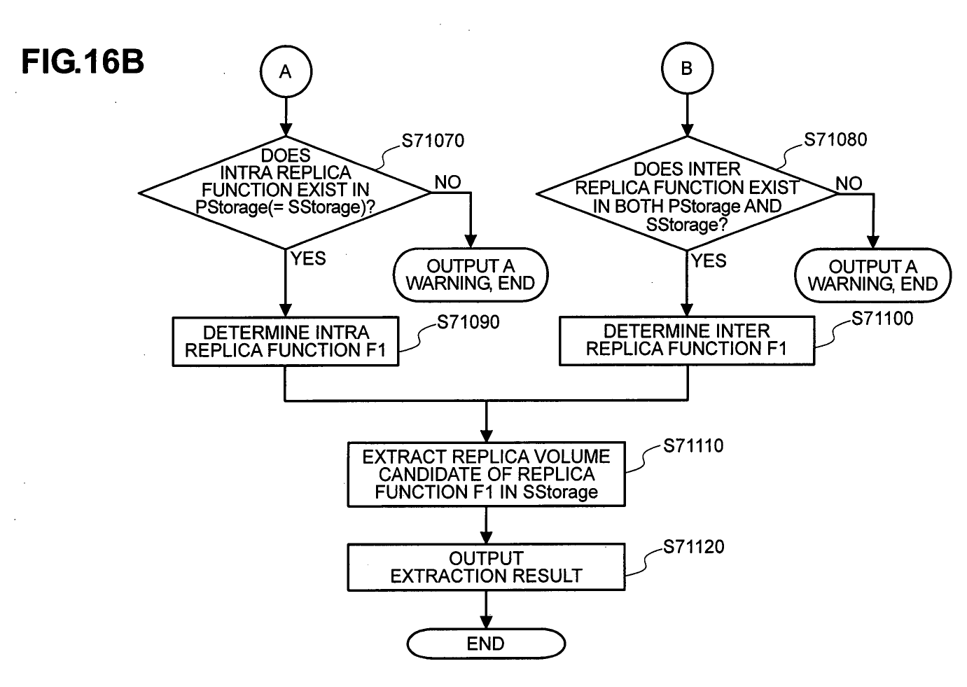

Next, details of Step S2000 of the computer system configuration information collection processing and Step S2200 of replica volume candidate extraction processing in the sequence for replica configuration creation of Embodiment 1 are explained using FIGS. 15 and 16.

A detailed flow of Step S2000 of the computer system configuration information collection processing is shown in FIG. 15. First, the configuration management program collects the configuration information from the host computer, switch, and storage system (Step S70010). Specifically, it is necessary to issue a configuration information acquisition request only to each device registered in the device discovery list 42200, taking the IP address registered in the IP address field 42230 as a destination, and acquire the configuration information.

Next, the configuration management program creates the usage management table 42300 based on the configuration information of the host computer acquired in Step S70010 (Step S70020). Specifically, the management agent 12100 of host computer 10000 uses a confirmation command for an execution process, the command being provided by the host computer's OS, and a command provided by each application for confirming the running status of the application, to acquire information on the application running in the host; then the configuration management program acquires the result in Step S70010. The configuration management program creates an entry for the usage management table where the information transmission destination host computer is “a usage execution host” and the running application is “usage”, based on the acquired result, and stores the entry. This step registers a usage the configuration management program allows the user to select. In this step, both the configuration information acquired from management agent 12100 of host computer 10000 and the configuration information registered by the user may be used.

Then, the configuration program creates the storage network connection management table based on the configuration information of the host computer, switch, and storage device acquired in Step S70010 (Step S70030). Specifically, zone definition information held by the switch is acquired, and the definition of each zone is taken as an entry for the storage network connection management table. However, an object belonging to each zone, which is grasped by the switch, is a WWN (World Wide Name) which is a unique identifier on the fibre channel not of the device, but of the I/O port. Therefore, although a detailed explanation is abbreviated, WWN information of the I/O port of the above device is acquired from the host computer or storage system, and, in the device list field of the storage network connection management table, the WWN information is converted into, not the WWN list, but a list of each device or I/O port of each device, and is registered. By means of this step, it is possible to identify which I/O port of which storage system a certain host computer can access.

Finally, the configuration management program creates the replica function management table based on the configuration information of the storage system, which was acquired in Step S70010 (Step S70040). Specifically, it is necessary to acquire only the information of the inter replica function and of the intra replica function that are currently available in this storage system, as the configuration information, and to store a result thus obtained as each entry for the replica function management table. At this time, for the inter replica function, information of the other device that implements this function is stored as well. By means of this step, the replica function of each storage system can be identified.

In Embodiment 1, as result of execution of the steps described in this detailed flow of step S2000, it is assumed that the configuration information stated in FIGS. 11 to 13 are acquired, so the explanation is continued.

A detailed flow Step S2200 replica volume candidate extraction processing is shown in FIG. 16.

First, the configuration management program receives a replica VOL candidate extraction request (Step S71010). In this request, configuration information of an original VOL and usage are designated. Note that the configuration information of the original VOL may be expressed in a pair composed of a host computer system and an LU ID, as an LU allocated to the host computer, or may be expressed in a pair composed of a storage system and a VOL ID, as a VOL within the storage system.

Next, the configuration management program checks an original VOL allocation destination host (hereinafter, PHost) and the storage system to which the original VOL belongs (hereinafter, PStorage) on the basis of the configuration information of the original VOL received in Step S71010 (Step S71020). Specifically, the LU management tables of all of the host computers are retrieved by taking as a key the pair of a host computer system and LU ID, or the pair of a storage system and VOL ID that was received as the configuration information of the original VOL. The host computer for a matched entry is PHost, and the storage system inserted in the VOL information of this entry is PStorage.

Then, the configuration management program checks whether or not the usage received in Step S71010 is consistent with PHost checked in Step S71020 (Step S71030). Specifically, it is necessary to retrieve from the usage management table only an entry that conforms to the usage received in Step S71010, and to check if the field of the host computer for accessing an original VOL of this entry is “N/A” or if PHost is registered. When this field is “N/A”, or when PHost is registered, the replica VOL with respect to the original VOL of PHost can be created with the designated usage, and this is judged as “consistent.” When the field is “consistent” in Step S71020, the procedure diverges to Step S71040. When the field is “inconsistent”, the result “inconsistency” is outputted to the user, thereby ending this process.

In Step S71040, the configuration management program determines a replica VOL allocation destination host (hereinafter, SHost) that corresponds to the usage. Specifically, it is necessary to obtain, as SHost, only the host computer where the entry for the usage management table, which is the retrieved result of Step S71030, is registered in the usage execution host field.

Next, the configuration management program checks if there is a storage system (hereinafter, SStorage) accessible from the SHost determined in Step S71040 (Step S71050). Specifically, it is necessary to extract only an entry including SHost, i.e., zone, from the entries of the storage network connection management table, and to take the storage system belonging to this zone as SStorage. Note that a plurality of SStorages can exist, in which case all of them may be considered SStorage, or the user may be allowed to select a storage system during processing by displaying a user selection screen or the like, or, the configuration management program may automatically select a storage system. Further, regarding SStorage, information that includes the I/O port accessible from SHost is to be held. When SStorage exists in Step S71050, the procedure diverges to Step S71060. When the SStorage does not exist, the result “nonexistent” is outputted and presented to the user, thereby ending this process.

Then, the configuration management program checks whether PStorage and SStorage are the same storage systems (Step S71060). If they are, the procedure diverges to Step S71070, and if different, the procedure diverges to Step S71080.

If the PStorage and SStorage are the same storage systems in Step S71060, the intra replica function must be used for copy pair creation. Thus, it is determined whether PStorage (=SStorage) can use the intra replica function (Step S71070). Specifically, it is necessary to retrieve only an entry that conforms to the PStorage from among the entries of respective storage systems of the replica function management table, and to determine whether the intra replica function is registered in the intra replica function field of this entry. If the intra replica function is can be used, an intra replica function (hereinafter, F1) to be used is determined (Step S71090), and the procedure proceeds to Step S71110. When the intra replica function cannot be used, this result is outputted and presented to the user, thereby ending the process. Note that when a plurality of available intra replica functions exist, all the functions may be considered as F1, or the user may allowed to perform function selection during processing by displaying the user selection screen or the like, or, the configuration management program may automatically select a function.

When the PStorage and SStorage are different storage systems in Step S71060, the inter replica function has to be used for copy pair creation. Thus, it is determined whether both the PStorage and SStorage can use the inter replica function (Step S71080). Specifically, it is necessary to retrieve only entries that conform with PStorage and SStorage, respectively, from among the entries of respective storage systems of the replica function management table, and to determine whether the inter replica function is registered as “available in PStorage and SStorage” in the inter replica function field of this entry. If the inter replica function can be used, an inter replica function (hereinafter, F1) is determined (Step S71100), and the procedure proceeds to Step 71110. If the inter replica function cannot be used, that result is outputted and presented to the user, thereby ending this process. Note that when a plurality of available inter replica functions exist, all the functions may be considered as F1, or the user may be allowed to perform function selection during processing by displaying the user selection screen or the like, or, the configuration management program may automatically select a function.

Once the replica function F1 used in Step S71090 or Step S71100 is determined, the configuration management program extracts, as a replica VOL candidate, a VOL where the replica function F1 can be applied in SStorage (Step S71110). Specifically, it is necessary to extract, among all the VOL entries of the VOL management table of SStorage, only a VOL that has already been allocated to the I/O port of SStorage, which is identified in Step S71040 as one the SHost can access, and an unallocated VOL, and to take them as replica VOL candidates. Note that if the replica function F1 is a function having constrained conditions for capacity and the like, with respect to the replica VOL, a replica VOL candidate is selected in view of these constrained conditions as well. Finally, the configuration management program outputs the replica VOL candidate extracted in Step S71110 as a result of replica volume candidate extraction processing (Step S71120).

The detailed flow of Step S2200, of replica volume candidate extraction processing follows. Two process examples for Step S2200 of replica volume candidate extraction processing are explained. In the first process example, the user gives the instruction “I wish to create a replica VOL for backup usage, with LU of host computer H1, H1Lu1, as an original VOL”.

In Step S71020, it is understood that the PHost of original VOL H1Lu1 is H1, PStorage is ST1, and VOL ID is st1v1; thus the procedure proceeds to Step S71030.

In Step S71030, the host computer for accessing an original VOL is not particularly designated for backup usage, and is indicated as “N/A”. Consequently it is determined that PHost is consistent with the usage, and SHost is H2 in Step S71040. Thus the procedure proceeds to Step S71050.

In Step S71050, it is understood that SHost H2 can access Port ID st1p3 of the storage system ST1; thus SStorage also is ST1. Therefore, PStorage conforms with SStorage, which means that the determination is “Yes” in Step S71060. Thus the procedure proceeds to Step S71070.

In Step S71070, since SStorage ST1 can use only Func3 as the intra replica function F1, the decision is “Yes”, and Func3 is determined as F1 in Step S71090, whereby the procedure proceeds to Step S71110.

In Step S71110, a VOL that is either allocated to Port ID st1p3 of storage system ST1 or unallocated is extracted, and as a result, three VOLs of st1v4, st1v5, and st1v8 are obtained as the replica VOL candidates, and are outputted in Step S71120. This is the first process example.

Next, a process example is explained in which the user gives the instruction “I wish to create a replica VOL for cluster usage, with an LU of host computer H1, H1Lu2, as an original VOL”.

In Step S71020, it is understood that the PHost of original VOL H1Lu2 is H1, PStorage is ST1, and VOL ID is st1v2; thus the procedure proceeds to Step S71030.

In Step S71030, the host computer for accessing an original VOL is limited to H1 for cluster usage; however, since PHost is H1, it is determined that PHost is consistent with the usage, and SHost is H3 in Step S71040. Thus the procedure proceeds to Step S71050.

In Step S71050, it is understood that SHost H3 can access Port ID st2p2 of storage system ST2; thus SStorage is ST2. Therefore, PStorage and SStorage are different storage systems, which means that the determination is “No” in S71060. Thus the procedure proceeds to Step S71080.

In Step S71080, since PStorage ST1 and SStorage ST2 can use only Func1 as the inter replica function F1, the decision is “Yes”, and Func1 is determined as F1 in Step S71100. Thus the procedure proceeds to Step S71110.

In Step S71110, a VOL that is either allocated to Port ID st2p2 of storage system ST2 or unallocated is extracted, and as a result, two VOLs of st2v3 and st2v4 are obtained as the replica VOL candidates, and are outputted in Step S71120.

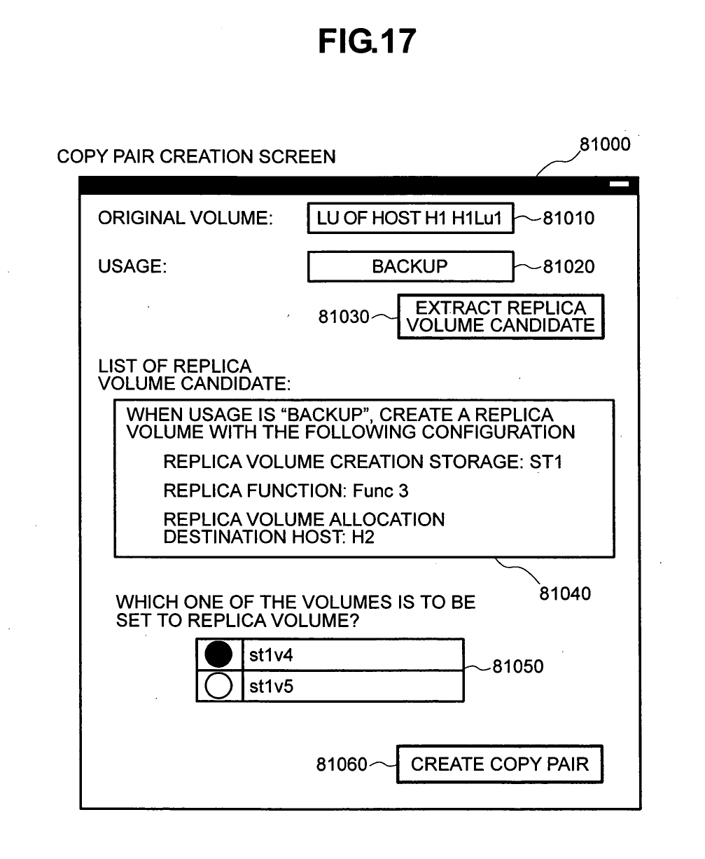

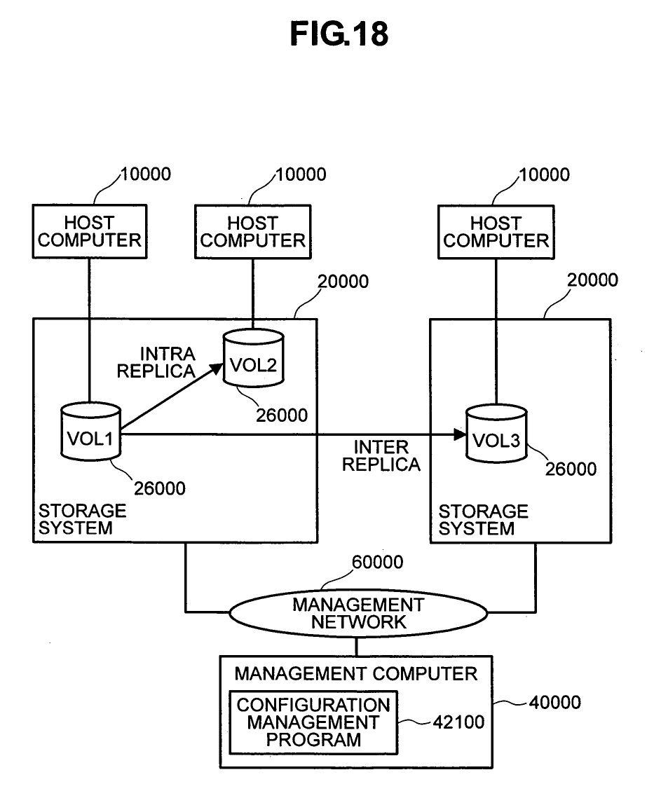

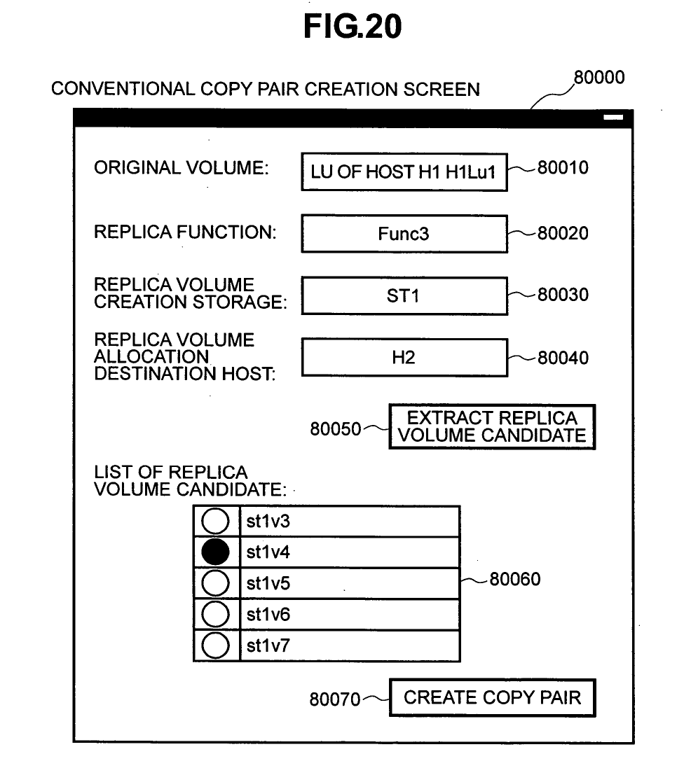

Finally, the difference in the user interface, which is provided to the storage administrator by the configuration management program of the prior art and that of Embodiment 1 is explained using FIG. 17 and FIG. 20.

In the conventional configuration management program, a copy pair creation screen 80000 as shown in FIG. 20 needs to be provided. Specifically shown are a region 80010 where the user designates an original VOL, region 80020 for designating a replica function, region 80030 for designating a replica VOL creation storage system, region 80040 for designating an allocation destination host, region 80050 for approving issuance of a replica VOL candidate extraction request, a region 80060 which displays a list of replica VOL candidates extracted by the configuration management program as a result of Step S2200 of replica volume candidate extraction processing and allows the user to select a replica VOL, and a region 80070 for approving creation of a copy pair using the selected replica VOL.

In the configuration management program of Embodiment 1, on the other hand, a copy pair creation screen 81000 as shown in FIG. 17 is provided. Specifically shown are a region 81010 where the user designates an original VOL, region 81020 for allowing the user to designate the usage created in Step S2000 of storage system configuration information collection processing, a region 81030 for approving issuance of the replica VOL candidate extraction request, a region 81040 which displays a list of replica VOL candidates extracted by the configuration management program as a result of Step S2200 of replica volume candidate extraction processing and allows the user to select a replica VOL, and region 81050 for approving creation of a copy pair using the selected replica VOL.

As above, in the conventional configuration management program, it was necessary to create a copy pair by designating four items in four regions. In this embodiment, however, by designating only two items of the original VOL and usage, a copy pair can be created. That is, designation of items by the user is reduced.

Further, in the copy pair creation screen 81000 in this embodiment, detailed designation for the replica VOL is not necessary. Thus even a storage administrator who is not familiar with the storage system can select a homogeneous replica VOL obtained from the replica volume candidate extraction processing, and create a copy pair by indicating a usage. In other words, all the storage administrators can carry out homogeneous copy pair creation work.

Specifically, in replica configuration creation, designation of items performed by the storage administrator is reduced more than ever before, and the burden of management imposed on storage administrators is lightened. Furthermore, all the storage administrators can perform replica configuration creation with the same user interface, and, regardless of experience or knowledge of the storage system, replica configuration work is homogenous; thus degradation of the computer system is prevented.

What is claimed is:

1. A method of configuration management of a computer system having a plurality of computers and at least one storage system which has a plurality of first storage regions for storing data used by the computers, and a control portion for controlling a request to the storage regions from the computers allocated to the storage regions, the method comprising:
receiving designations of usage of the first storage regions and a second storage region for storing replicated data of data stored in the first storage regions;
specifying a computer to execute information about the designations;
extracting the second storage region based on the specified computer;
transmitting, to the storage system, an allocation instruction for allocating the extracted storage region to the specified computer, via a network.

2. The method of configuration management of a computer system according to claim 1, wherein the second storage region is extracted based on whether the second storage region is a storage region which can store the replicated data.

3. The method of configuration management of a computer system according to claim 2, wherein the storage system extracts a storage region possessed by the storage system as the second storage region on the basis of whether the replicated data of the first storage region can be stored in the second storage region.

4. The method of configuration management of a computer system according to claim 1, wherein a certain storage system has the first storage region and the second storage region in which the replicated data is stored.

5. The method of configuration management of a computer system according to claim 4, wherein the second storage region is extracted when the replicated data can be stored in the second storage region from the first storage region.

6. The method of configuration management of a computer system according to claim 1, wherein a first storage system includes the first storage region; and
a second storage system coupled to the first storage system via a network includes the second storage region.

7. The method of configuration management of a computer system according to claim 6, wherein if replicated data is sent from the first storage system to the second storage system via the network, the second storage region possessed by the second storage system is extracted.

8. The method of configuration management of a computer system according to claim 1, wherein when a plurality of storage regions are extracted based on the specified computers, the storage system is instructed to allocate any of the storage regions to the specified computers.

9. The method of configuration management of a computer system according to claim 1, wherein the computer which executes the usages is specified based on the usages and a computer which uses the data stored in the first storage region.

10. The method of configuration management of a computer system according to claim 9 wherein the usage is clustering.

11. The method of configuration management of a computer system according to claim 1 wherein the usage is previously defined on the basis of configuration information of an application which can be executed on the computer.

12. The method of configuration management of a computer system according to claim 1, further comprising:
outputting the extraction result to receive an input corresponding to the output; and
executing specification of the computer executing the usage, on the basis of the usage and the computer which uses the data,
wherein the second storage region is a storage region which can be accessed by the computer executing the usage, can store the replicated data stored in the first storage region, and is extracted from the storage regions possessed respectively by at least one or more of the storage systems, and
wherein the allocation instruction is an instruction to store the replicated data in the second storage region, the instruction being designated by the input.

13. A management computer which is connected to a plurality of computers via a first network, and to a storage system having a storage region which store data used by the computers via a second network, the management computer comprising:
an interface which can be connected to the network;
a control portion connected to the interface;
an input portion connected to the control portion; and
an output portion connected to the control portion,
wherein the control portion:
receives, via the input portion, designations of usages of a first storage region and a second storage region for storing replicated data of data stored in the first storage region;
specifies a computer for executing the usages on the basis of the usages and the computer which uses the data;
extracts, from storage regions that are possessed respectively by at least one or more of the storage systems, the second region which can be accessed by a second computer and which can store the replicated data stored in the first storage region;
outputs the extraction result to the output portion; and
transmits an instruction for storing the replicated data in the second storage region to the storage system via the first network, the instruction being designated by an input with respect to the output result.

14. The management computer according to claim 13, wherein the control portion collects beforehand information of an application which can be executed by the computer corresponding to the usages, information on connection between the computer and storage system, and information on whether or not data can be replicated among the storage regions, and extracts the computer executing the usages, and the second storage region.

15. A computer system, comprising:
a computer;
a storage system having a storage region which stores data used by the computer via a network; and
a management computer which can be connected to the computer and the storage system via a network,
wherein the management computer:
collects information of an application which can be executed by the computer corresponding to a usage, information on connection between the computer and storage system, and replicability information regarding whether or not data can be replicated among the storage regions,
receives designations of usages of a first storage region and second storage region for storing replicated data of data stored in the first storage region,
specifies a computer for executing the usages on the bases of the application information and the computer which uses the data,
extracts the second storage region, which can be accessed by a second computer and which can store the replicated data stored in the first storage region, from the storage regions possessed respectively by at least one or more of the storage systems, on the basis of the connection information and the replicability information,
outputs the extraction result to an output portion, and
transmits to the storage system via a network, a storage instruction for storing the replicated data in the second storage region the instruction being designated by an input for the output result,
wherein the storage system:
holds the connection information and the replicability information, and transmits the connection information and replicability information to the management computer in response to the collection of the management computer; and
receives the storage instruction to set an access to the second storage region from the computer executing the usages, and
wherein the computer holds the application information and the connection information, and transmits the application information and the connection information to the management computer in response to the collection of the management computer.
